(19) United States
(12) Patent Application Publication
(10) Pub. No.: US 2026/0368843 A1
(43) Pub. Date: Nov. 19, 2026

(54) FOVEATED COORDINATE PATCHING

(71) Applicant: QUALCOMM Incorporated, San Diego, CA (US)

(72) Inventors: Maxime DESCOS, San Diego, CA (US); Brian ELLIS, San Diego, CA (US)

(21) Appl. No.: 19/095,908

(22) Filed: Mar. 31, 2025

(51) Int. Cl. G06T 1/20; G06T 3/40; G06T 7/11; G06T 15/80

(52) U.S. Cl. CPC G06T 1/20; G06T 3/40; G06T 7/11; G06T 15/80

(57) ABSTRACT

This disclosure provides systems, devices, apparatus, and methods, including computer programs encoded on storage media, for foveated coordinate patching. A graphics processor may obtain, for a fragment of image data, a resolution scale and a set of offsets associated with foveation. The graphics processor may adjust, at a graphics processor and based on the resolution scale and the set of offsets, a set of initial coordinates of the fragment to obtain a set of patched coordinates of the fragment. The graphics processor may output a coordinate indication of the set of patched coordinates.

### TECHNICAL FIELD

The present disclosure relates generally to processing systems and techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for graphics processing may utilize software-based patches at a graphics driver for coordinates of fragments associated with applications in foveated rendering, but may not address the performance and maintenance impacts for software-based patching. There is a need for improved techniques for coordinate patching of fragments associated with applications in foveated rendering.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: obtain, for a fragment of image data, a resolution scale and a set of offsets associated with foveation; to adjust, at a graphics processor and based on the resolution scale and the set of offsets, a set of initial coordinates of the fragment to obtain a set of patched coordinates of the fragment; and to output a coordinate indication of the set of patched coordinates.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 illustrates an example of software coordinate patching for foveation in accordance with one or more techniques of this disclosure.

FIG. 5 illustrates an example of hardware-based foveated coordinate patching in accordance with one or more techniques of this disclosure.

FIG. 6 illustrates an example of hardware-based foveated coordinate patching in accordance with one or more techniques of this disclosure.

FIG. 7 is a call flow diagram illustrating example communications between a CPU and a graphics processor in accordance with one or more techniques of this disclosure.

FIG. 8 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

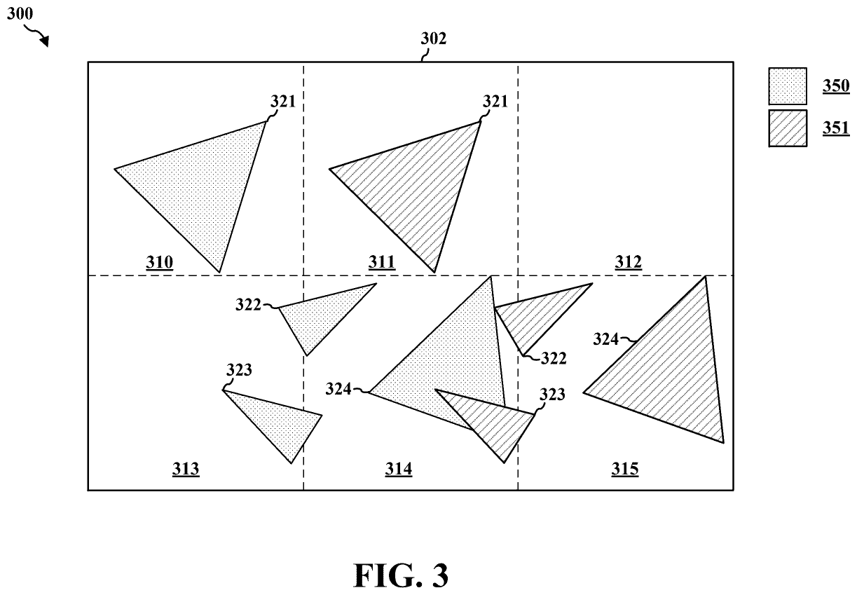

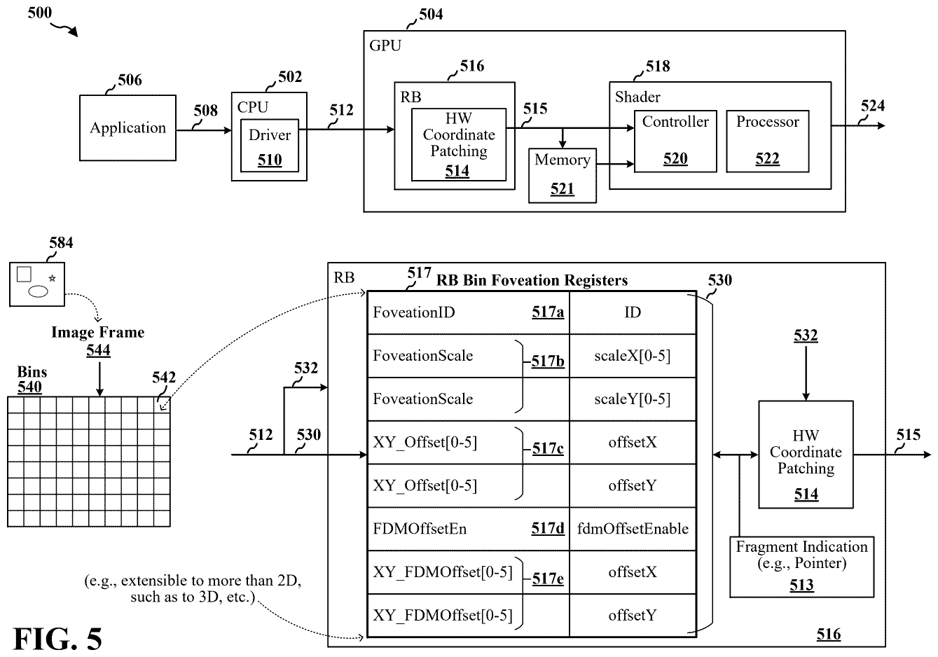

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, instances of the terms “fragment” or “image fragment” may refer to a set of pixels or a portion of a surface or primitive associated with the image data. As used herein, the term “render backend” may refer to a processing block of a graphics processor that produces, blends, and/or writes final colors of pixels and/or fragments of a surface for display. As used herein, the term “coordinate patching” may refer to correction of image fragment locations or positioning affected during bin-based foveation for render passes. As used herein, the term “resolution scale” may refer to a downscaling or a sub-sampling factor applied to image data or a portion thereof (e.g., full resolution (1:1 scaling factor), mid-resolution (2:1 scaling factor), low-resolution (4:1 scaling factor), etc. As used herein, the term “offsets associated with foveation” may refer to location-based offsets for fragments to correct positioning affected during bin-based foveation for render passes. As used herein, the term “render pass” may refer to a set of operations, performed on a per-bin basis, by which visible draws, primitives, fragments, and the like, are rendered to the render target. As used herein, the term “per-view offsets” may refer to offsets associated with foveation that correspond to one or more different rendering viewpoints in an image, as described herein such as with respect to FIGS. 3 and 5 below. As used herein, the term “shader controller” may refer to a function or mechanism of a graphics processor that controls and/or modifies parameters for a shader, and the term “shader processor” may refer to a function or mechanism of a graphics processor that performs lighting, colorizing, texturizing, etc., for rendering objects.

On a foveated render pass for image content, a surface may be downscaled by fixed function blocks (e.g., a triangle setup engine (TSE), a rasterizer (RAS), a low resolution Z (LRZ) pass, and/or the like) to cover fewer fragments. This reduces the workload for fixed function blocks, as well as the number of iterations for a fragment shader. When a shader controller receives coordinates from a render backend (RB), these coordinates are for the downscaled fragment currently covered. However, application developers may not be aware of the foveation pattern utilized, and application-provided shaders may be written to behave over a full surface. Hence, the original coordinates may be patched by a graphics driver (e.g., during compilation) to avoid a discrepancy between the fragment location and the full surface coordinates. Software patching may be tedious and time consuming, as well as fragile to maintain in a graphics driver, and implicates a large safety surface area or a security surface area (e.g., associated with safety or security issues due to graphics driver code and/or patching quantity or quality), and can impact performance. Current coordinates are read from a shader constant buffer, and the current coordinates are patched for each bin.

Aspects herein provide for graphics processing with foveated coordinate patching, e.g., by an RB. Initial or original initial or original initial or original Aspects herein describe, when foveation is enabled, techniques for the RB to select the correct scale and offset. With the correct scale and offset, the RB may modify the initial or original coordinates to generate patched coordinates (e.g., full size coordinates) before sending to a shader controller or a shader processor based on the following equation (Eq. 1):

fullSizeCoordinates=((RBCoordinates−foveatOffset)*scaleFactor)−FDMOffset (Eq. 1)

where the RBCoordinates are the initial or original coordinates received by the RB, the FDMOffset is a fragment density map (FDM) offset based on an FDM associated with the application, the scaleFactor is a scale factor which may, in some examples, be a power of 2 (e.g., 1, 2, 4, etc.), and the foveatOffset is the offset for the fragment that is subject to foveation.

Aspects provide for a graphics processor to perform coordinate adjustments in hardware. For instance, a graphics processor may be configured to obtain a resolution scale and a set of offsets associated with foveation for a fragment of image data from registers at an RB of the graphics processor. The RB may then adjust, based on the resolution scale and the set of offsets for the foveation, the initial coordinates of the fragment to obtain patched coordinates of the fragment. The RB may next output, e.g., to a render processor and/or a memory for the render processor, a coordinate indication of the patched coordinates for a tile-based foveated render pass of the image content. Accordingly, aspects enable coordinate adjustments of image fragments for various applications at a high level of performance and confidence for foveated rendering.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

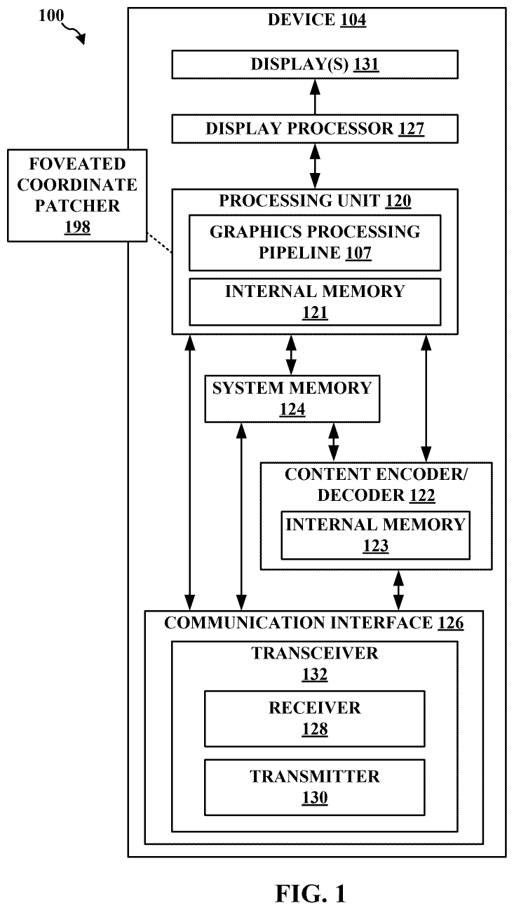

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a foveated coordinate patcher 198 configured to obtain, for a fragment of image data, a resolution scale and a set of offsets associated with foveation, to adjust, at a graphics processor and based on the resolution scale and the set of offsets, a set of initial coordinates of the fragment to obtain a set of patched coordinates of the fragment, and to output a coordinate indication of the set of patched coordinates. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

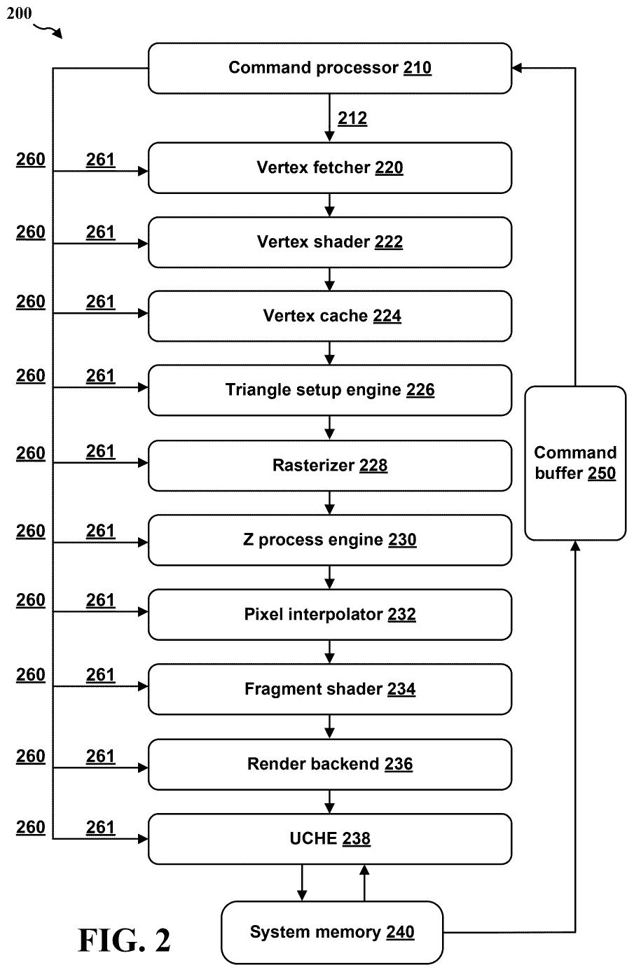

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

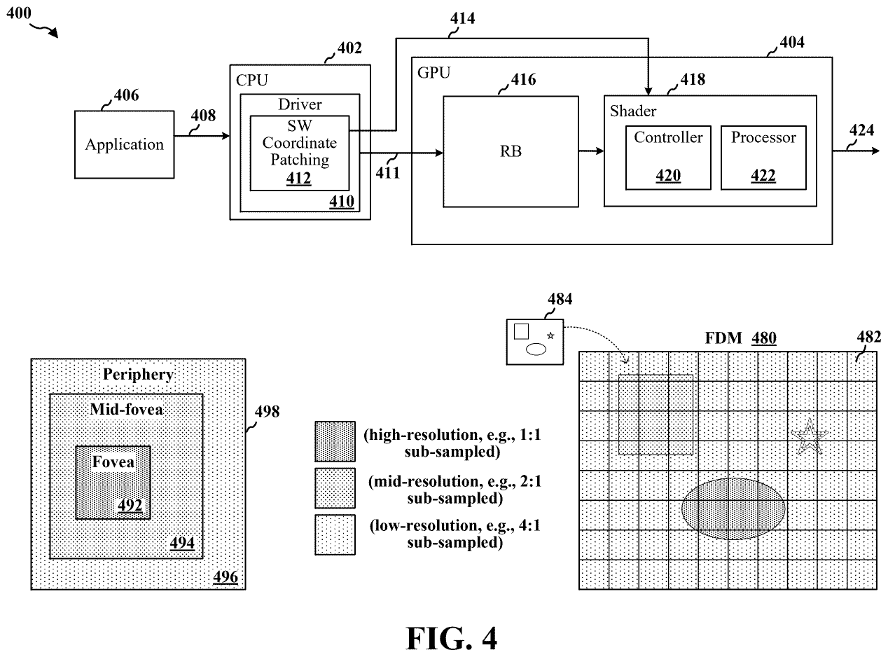

FIG. 4 illustrates a diagram 400 for an example of software coordinate patching for foveation in accordance with one or more techniques of this disclosure.

Humans see more details near a focal point, and sensitivity to perceive details drops radially while moving away from the focal point, such as a fovea field of view (FOV) 492. The fovea FOV 492 (e.g., a small FOV) is shown with a full or 1:1 resolution and no downscaling, for an image frame 498 comprised of image data 484. Image frame 498 also includes a mid-fovea FOV 494 (e.g., a medium FOV) at downscaled by 2 (DS2) resolution (2:1) and a periphery FOV 496 (e.g., a full FOV) at downscaled by 4 (DS4) resolution (4:1), by way of example. In the context of binned rendering or bin-based rendering (e.g., tiled rendering) with foveation, an application 406 may provide a FDM 480 based on a number of bins 482 for image content of an image frame. In such configurations, foveation may be based on tiles corresponding to portions of the image content for which a user's gaze will, or will likely be, centered or focused.

In the context of software-based coordinate patching, an application 406 may provide application data 408 that includes the image data 484, fragment data (e.g., initial or original coordinates 411 of fragments), an associated FDM, etc. A CPU 402 may receive the application data 408, and a graphics driver 410 may provide the initial or original coordinates 411 to an RB 416 of a GPU 404. The graphics driver 410 may also perform software-based coordinate patching (at 412) on the initial or original coordinates 411 of fragments to generate patched coordinates 414 for tile- or bin-based rendering with foveation (e.g., rendering with foveation on a per-bin or per-tile basis). The RB 416 of the GPU 404 may receive the initial or original coordinates 411 from the graphics driver 410, and may perform processing to produce, blend, and/or write final colors of pixels or fragments of a surface for display to the user. The output of the RB 416 is provided to a shader controller 420 of a shader 418 (e.g., of the GPU 404) for shader processing of the fragments by a shader processor 422. The graphics driver 410 may modify the initial or original coordinates 411 at the shader 418 with the patched coordinates 414 for consumption by the shader 418 during the shader processing by the shader processor 422. After the shader processing, processed image data 424 with coordinate-corrected fragments may be output to a display processor and/or a display panel for viewing by a user. However, as noted above, issues may arise from the use of the software-based coordinate patching (at 412).

FIG. 5 illustrates a diagram 500 for an example of hardware-based foveated coordinate patching in accordance with one or more techniques of this disclosure. Diagram 500 shows a graphics processor (e.g., a GPU 504, by way of example) that includes an RB 516 and RB bin foveation registers 517 that may be utilized in hardware-based foveated coordinate patching (e.g., at 514), according to aspects.

In aspects for hardware-based foveated coordinate patching (e.g., at 514), an application 506 may provide application data 508 that includes image data 584, fragment data (e.g., which may include the fragments), initial or original coordinates (e.g., a set of initial coordinates) of fragments, an associated FDM, etc. A CPU 502 may receive the application data 508, and a graphics driver 510 may compile (e.g., via a compiler) the application data 508, or a portion thereof, and provide it to the RB 516 (e.g., including initial or original coordinates for fragments, a resolution scale, a set of offsets, etc., which may be per-fragment). The RB 516 may receive or obtain the compiled application data 512 from the graphics driver 510, and may be configured to perform hardware-based foveated coordinate patching (at 514) on the initial or original coordinates of fragments to generate or obtain patched coordinates 515 (e.g., a set of patched coordinates) of the fragments for tile- or bin-based rendering with foveation (e.g., rendering with foveation on a per-bin or per-tile basis). The RB 516 may also perform processing to produce, blend, and/or write final colors of pixels or fragments of a surface for display to the user. The output of the RB 516, including the patched coordinates 515 of the fragment, may be provided to a shader controller 520 of a shader 518 for shader processing of the fragments by a shader processor 522. In aspects, the RB 516 may be configured to store the patched coordinates 515 in a memory 521 of the GPU 504 for the shader controller 520. Processed image data 524 with coordinate-corrected fragments may be output to a display processor or a display panel for viewing by a user.

In the context of binned rendering or bin-based rendering (e.g., tiled rendering) with foveation, the application 506 may provide a FDM as part of the application data 508 based on a set of bins 540 comprising a number of instances of a bin 542 for image data 584 of an image frame 544 (e.g., image content). That is, the frame buffer for the image frame 544 may be partitioned into the set of bins 540 bins (or tiles). In such configurations, foveation may be based on the set of bins 540 or tiles corresponding to portions of the image data 584 of the image frame 544 for which a user's gaze will, or will likely be, centered or focused.

A fragment may be within one or more bins (e.g., the bin 542) of the set of bins 540. In aspects, each bin (e.g., the bin 542) of the set of bins 540 may have a corresponding set of hardware registers of the RB bin foveation registers 517 having corresponding register values (e.g., register values 530), which may be a portion of fragment data. Each set of hardware registers of the RB bin foveation registers 517 may include, without limitation, a foveation identifier (ID) register 517a with an ID value, foveation scale registers 517b with scaleX[0-5] and scaleY[0-5] values (e.g., per-view for views [0-5], by way of example), X/Y offset registers 517c (e.g., per-view for views [0-5], by way of example) with offsetX and offsetY values, an FDM offset enable register 517d with an fdmOffsetEnable value, and X/Y FDM offset registers 517e (e.g., per-view for views [0-5], by way of example) with offsetX and offsetY values, and/or the like. In aspects, one or more views may be utilized for bin-based rendering with foveation (e.g., for 6 or [0-5] views, front, back, left, right, top, and bottom views may be utilized). Views may be considered in a hardware context, with values, and each view may reside in a slice of a frame buffer (e.g., views of left eye and right eye); per-view aspects may include operations to be performed on individual views (e.g., of 6 or [0-5] possible views).

The ID value may identify a bin (e.g., the bin 542) of the set of bins 540 and may serve as an enable for bin-based rendering with foveation, the scaleX[0-5] and scaleY[0-5] values may be a power of 2 (e.g., 1, 2, 4, etc.) and may indicate a downscaling factor (e.g., a 1:1 scaling factor, a 2:1 scaling factor), a 4:1 scaling factor, etc.) the offsetX and offsetY values of the X/Y offset register 517c may indicate fragment location offsets with respect to initial or original coordinates 532 (e.g., a set of initial coordinates), the fdmOffsetEnable value may indicate if an FDM offset is enabled, and the offsetX and offsetY values of X/Y FDM offset registers 517e may indicate FDM offsets with respect to initial or original coordinates 532.

While two-dimensional examples are described and illustrated, aspects are extensible to greater than two dimensions (e.g., three dimensions, etc.). Register values 530, as described for each set of registers of the RB bin foveation registers 517 in this example, may be provided as part of the compiled application data 512 from the graphics driver 510, along with the initial or original coordinates 532 of fragments associated with the compiled application data 512.

In aspects, the RB 516 may obtain the register values 530 for the fragment of the image data 584 associated with the foveation from the RB bin foveation registers 517. In some aspects, the RB 516 may obtain a fragment indication 513 of the fragment of the image data 584 associated with the foveation. The fragment indication 513 may be a pointer or the like to the fragment data (e.g., which may comprise the resolution scale value (scaleX[0-5]/scaleY[0-5]) and the set of offsets (offsetX/offsetY) for the X/Y offset registers 517c and the X/Y FDM offset registers 517e). Based on the register values 530 for the fragment and the initial or original coordinates 532 (e.g., a set of initial coordinates) for the fragment, the RB 516 may be configured to perform the hardware-based foveated coordinate patching (at 514) to generate or obtain the patched coordinates 515 (e.g., a set of patched coordinates) in hardware (e.g., according to Eq. 1, noted above, and/or the like) and without software-based coordinate patching at the graphics driver 510.

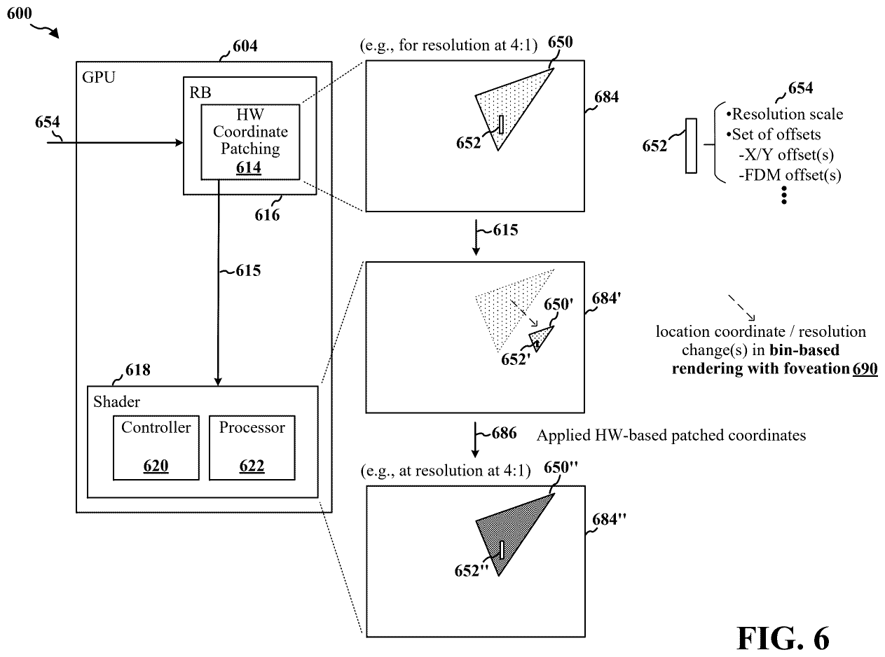

FIG. 6 illustrates a diagram 600 for an example of hardware-based foveated coordinate patching in accordance with one or more techniques of this disclosure. Diagram 600 may be an aspect of diagram 500 in FIG. 5. Diagram 600 shows a graphics processor (e.g., a GPU 604, by way of example) that includes an RB 616 that may be utilized in hardware-based foveated coordinate patching (e.g., at 614) for a fragment 652, according to aspects.

In aspects, the fragment 652 may be a set of pixels that comprises a portion of a primitive or surface 650 associated with image data 684. The fragment 652 may have fragment data 654 associated therewith. The fragment data 654 may include, without limitation, initial or original coordinates (e.g., a set of initial coordinates) of the fragment 652 with respect to the image data 684, a resolution scale associated with foveation, a set of offsets associated with foveation (e.g., a location offset of the fragment 652, an FDM offset, etc.), and/or the like. In the illustrated example for diagram 600, the fragment 652 may be associated with a bin for bin-based foveation of the image data 684, and the foveation may be for a downscaled resolution of 4:1. The RB 616 may receive the fragment data 654, as described herein (e.g., from a graphics driver) and perform hardware-based foveation coordinate patching (at 614), based at least in part on the fragment data 654, to generate or obtain patched coordinates 615 (e.g., a set of patched coordinates) for the fragment 652. In aspects, to perform the hardware-based foveation coordinate patching (at 614), the GPU 604 and/or the RB 616 may be configured to adjust, based on the resolution scale and the set of offsets (e.g., of the fragment data 654), the initial coordinates (e.g., a set of initial coordinates) of the fragment 652 to obtain the patched coordinates 615 (e.g., a set of patched coordinates) of the fragment 652. To adjust, the GPU 604 or the RB 616 may be configured to adjust, based on the resolution scale and the set of offsets, the set of initial coordinates of the fragment 652, and to obtain, based on the adjusted set of initial coordinates of the fragment 652, the patched coordinates 615 of the fragment 652.

In aspects, the primitive or surface 650 and the fragment 652 associated with the image data 684 may undergo location coordinate changes and/or resolution re-scaling during bin-based rendering with foveation 690, as shown for image data 684′, a primitive or surface 650′, and a fragment 652′. A shader 618, e.g., including a shader controller 620 and a shader processor 622, as described herein) may perform the bin-based rendering with foveation 690, and may be configured to apply (at 686) the patched coordinates 615 for the fragment 652 in associated with the bin-based rendering with foveation 690 as shown for image data 684″, a primitive or surface 650″, and a fragment 652″.

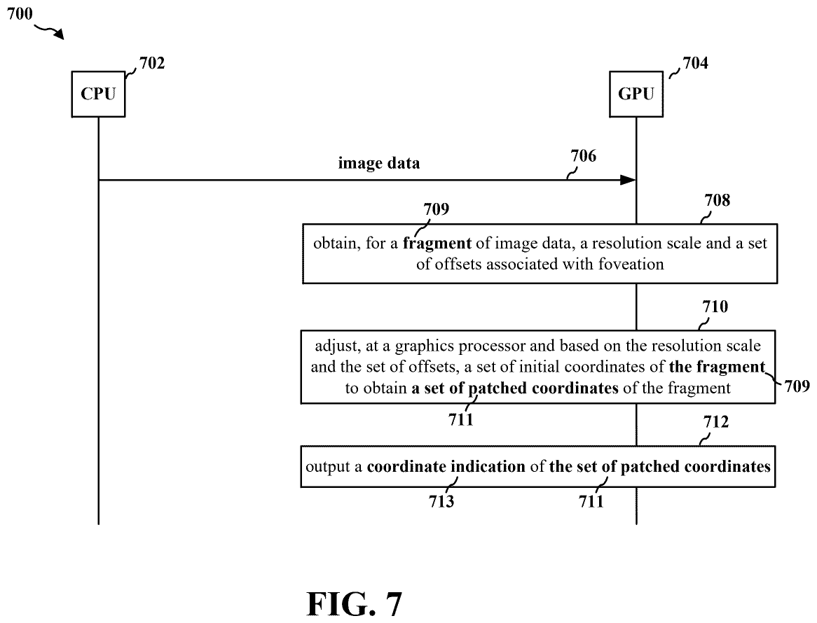

FIG. 7 is a call flow diagram 700 illustrating example communications between a CPU 702 and a graphics processor 704 in accordance with one or more techniques of this disclosure. In aspects, call flow diagram 700 is described for foveated coordinate patching, such as hardware-based foveated coordinate patching. In an example, the graphics processor 704 may be or include the processing unit 120 and/or the foveated coordinate patcher 198. In some aspects, the graphics processor 704 may be a CPU or a GPU. In aspects, the graphics processor 704 comprises a wireless communication device that is configured to perform the call flow diagram 700.

The graphics processor 704 may be configured to receive or obtain, and the CPU 702 may be configured to provide, image data 706. The image data 706 may include a fragment 709 (e.g., an image fragment), which may be a set of pixels that comprises a portion of a primitive or surface associated with image data 706. The fragment 709 may have fragment data associated therewith that is included in the image data 706. The fragment data may include, without limitation, initial or original coordinates (e.g., a set of initial coordinates) of the fragment 709 with respect to the image data 706, a resolution scale associated with foveation, a set of offsets associated with foveation (e.g., a location offset of the fragment 709, an FDM offset, etc.), and/or the like. In aspects, the fragment 709 may be associated with a bin for bin-based foveation of the image data 706, as described herein. In aspects, the resolution scale associated with the foveation may be based on a power of 2, and may be one of a full resolution, a downscaled-by-two resolution, or a downscaled-by-four resolution, etc. In aspects, the set of offsets associated with the foveation correspond to location coordinate changes, in one or more of two dimensions or in one or more of three dimensions, between image frames in the image data 706. In aspects, the image frames may be partitioned over a set of bins, and the resolution scale and the set of offsets associated with the foveation may correspond to one bin of the set of bins. In aspects, the image data 706 may be associated with a software application and includes an FDM associated with the fragment 709, and the set of offsets associated with the foveation includes at least one FDM offset based on the FDM. In aspects, the set of offsets may include respective per-view offsets associated with a set of views for the fragment 709 of the image data 706.

At 708, the graphics processor 704 may be configured to obtain, for a fragment 709 of the image data 706, a resolution scale and a set of offsets associated with foveation. In aspects, to obtain the resolution scale and the set of offsets associated with the foveation, the graphics processor 704 may be configured to receive the resolution scale and the set of offsets associated with the foveation via hardware registers (e.g., a set of hardware registers) associated with an RB of the graphics processor 704. In aspects, to obtain the resolution scale and the set of offsets associated with the foveation, the graphics processor 704 may be configured to obtain the resolution scale and the set of offsets associated with the foveation based on a foveation enable indication stored in one of the hardware registers. In aspects, to obtain the resolution scale and the set of offsets associated with the foveation, the graphics processor 704 may be configured to obtain a fragment indication of the fragment 709 of the image data 706 associated with the foveation. In aspects, the fragment indication of the fragment 709 of the image data 706 may be a pointer to data associated with the fragment 709 of the image data 706, where the data comprises the resolution scale and the set of offsets.

At 710, the graphics processor 704 may be configured to adjust, based on the resolution scale and the set of offsets, initial or original coordinates (e.g., a set of initial coordinates) of the fragment 709 to obtain patched coordinates 711 (e.g., a set of patched coordinates) of the fragment 709. In aspects, the graphics processor 704 and/or an RB thereof may be configured to perform hardware-based foveated coordinate patching to generate or obtain the patched coordinates 711 of the fragment 709 in hardware (e.g., according to Eq. 1, noted above, and/or the like) and without software-based coordinate patching at a graphics driver. In aspects, to adjust (at 710), the graphics processor 704 and/or an RB thereof may be configured to adjust, based on the resolution scale and the set of offsets, the set of initial coordinates of the fragment 709, and to obtain, based on the adjusted set of initial coordinates of the fragment 709, the patched coordinates 711 of the fragment 709.

At 712, the graphics processor 704 may be configured to output a coordinate indication 713 of the patched coordinates 711 (e.g., a set of patched coordinates). In aspects, to output (at 712) the coordinate indication 713 of the patched coordinates 711, the graphics processor 704 may be configured to provide the coordinate indication 713 of the patched coordinates 711 to a shader of the graphics processor, and/or to store the coordinate indication 713 of the patched coordinates 711 in a memory. In aspects, the coordinate indication 713 may comprise the patched coordinates 711 and/or some other indication thereof. In aspects, the shader of the graphics processor 704 may include at least one of a shader processor or a shader controller.

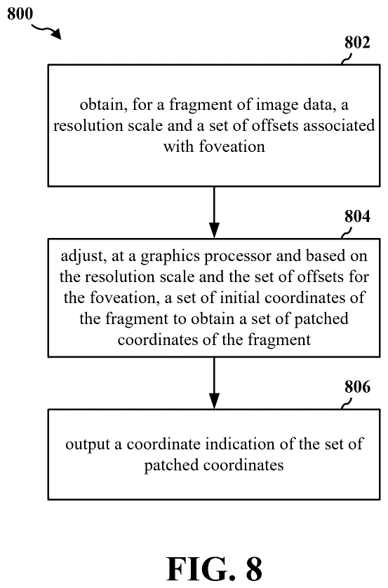

FIG. 8 is a flowchart 800 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-7.

At 802, the apparatus may obtain, for a fragment of image data, a resolution scale and a set of offsets associated with foveation. For example, referring to FIG. 7, the graphics processor 704 may be configured to receive or obtain, and the CPU 702 may be configured to provide, image data 706 (e.g., 584 in FIG. 5; 684 in FIG. 6). The image data 706 (e.g., 584 in FIG. 5; 684 in FIG. 6) may include a fragment 709 (e.g., 652 in FIG. 6) (e.g., an image fragment), which may be a set of pixels that comprises a portion of a primitive or surface (e.g., 650 in FIG. 6) associated with image data 706 (e.g., 584 in FIG. 5; 684 in FIG. 6). The fragment 709 (e.g., 652 in FIG. 6) may have fragment data (e.g., 530 in FIG. 5; 654 in FIG. 6) associated therewith that is included in the image data 706 (e.g., 584 in FIG. 5; 684 in FIG. 6). The fragment data (e.g., 530 in FIG. 5; 654 in FIG. 6) may include, without limitation, initial or original coordinates (e.g., 532 in FIG. 5) (e.g., a set of initial coordinates) of the fragment 709 (e.g., 652 in FIG. 6) with respect to the image data 706 (e.g., 584 in FIG. 5; 684 in FIG. 6), a resolution scale (e.g., of 517b in FIG. 5) associated with foveation (e.g., 690 in FIG. 6), a set of offsets (e.g., of 517c, of 517e in FIG. 5) associated with foveation (e.g., 690 in FIG. 6) (e.g., a location offset of the fragment 709 (e.g., 652 in FIG. 6), an FDM offset (e.g., of 517e in FIG. 5), etc.), and/or the like. In aspects, the fragment 709 (e.g., 652 in FIG. 6) may be associated with a bin for bin-based foveation (e.g., 690 in FIG. 6) of the image data 706 (e.g., 584 in FIG. 5; 684 in FIG. 6), as described herein. In aspects, the resolution scale (e.g., of 517b in FIG. 5) associated with the foveation (e.g., 690 in FIG. 6) may be based on a power of 2, and may be one of a full resolution, a downscaled-by-two resolution, or a downscaled-by-four resolution, etc. In aspects, the set of offsets (e.g., of 517c, of 517e in FIG. 5) associated with the foveation (e.g., 690 in FIG. 6) correspond to location coordinate changes, in one or more of two dimensions or in one or more of three dimensions, between image frames (e.g., 544 in FIG. 5) in the image data 706 (e.g., 584 in FIG. 5; 684 in FIG. 6). In aspects, the image frames (e.g., 544 in FIG. 5) may be partitioned over a set of bins (e.g., 540 in FIG. 5), and the resolution scale (e.g., of 517b in FIG. 5) and the set of offsets (e.g., of 517c, of 517e in FIG. 5) associated with the foveation (e.g., 690 in FIG. 6) may correspond to one bin (e.g., 542 in FIG. 5) of the set of bins (e.g., 542 in FIG. 5). In aspects, the image data 706 (e.g., 584 in FIG. 5; 684 in FIG. 6) may be associated with a software application and includes an FDM (e.g., 480 in FIG. 4) associated with the fragment 709 (e.g., 652 in FIG. 6), and the set of offsets (e.g., of 517c, of 517e in FIG. 5) associated with the foveation (e.g., 690 in FIG. 6) includes at least one FDM offset (e.g., of 517e in FIG. 5) based on the FDM. In aspects, the set of offsets (e.g., of 517c, 517e in FIG. 5) may include respective per-view offsets associated with a set of views for the fragment 709 (e.g., 652 in FIG. 6) of the image data 706 (e.g., 584 in FIG. 5; 684 in FIG. 6). At 708, the graphics processor 704 may be configured to obtain, for a fragment 709 (e.g., 652 in FIG. 6) of the image data 706 (e.g., 584 in FIG. 5; 684 in FIG. 6), a resolution scale (e.g., of 517b in FIG. 5) and a set of offsets (e.g., of 517c, 517e in FIG. 5) associated with foveation (e.g., 690 in FIG. 6). In aspects, to obtain the resolution scale (e.g., of 517b in FIG. 5) and the set of offsets (e.g., of 517c, 517e in FIG. 5) associated with the foveation (e.g., 690 in FIG. 6), the graphics processor 704 may be configured to receive the resolution scale (e.g., of 517b in FIG. 5) and the set of offsets (e.g., of 517d, 517e in FIG. 5) associated with the foveation (e.g., 690 in FIG. 6) via hardware registers (e.g., 517 in FIG. 5) associated with an RB (e.g., of 516 in FIG. 5; 616 in FIG. 6) of the graphics processor 704. In aspects, to obtain the resolution scale (e.g., of 517b in FIG. 5) and the set of offsets (e.g., of 517c, 517e in FIG. 5) associated with the foveation (e.g., 690 in FIG. 6), the graphics processor 704 may be configured to obtain the resolution scale (e.g., of 517b in FIG. 5) and the set of offsets (e.g., of 517c, 517e in FIG. 5) associated with the foveation (e.g., 690 in FIG. 6) based on a foveation enable indication (e.g., 517a in FIG. 5) stored in one of the hardware registers (e.g., 517 in FIG. 5). In aspects, to obtain the resolution scale and the set of offsets associated with the foveation (e.g., 690 in FIG. 6), the graphics processor 704 may be configured to obtain a fragment indication (e.g., 513 in FIG. 5) of the fragment 709 (e.g., 652 in FIG. 6) of the image data 706 (e.g., 584 in FIG. 5; 684 in FIG. 6) associated with the foveation (e.g., 690 in FIG. 6). In aspects, the fragment indication (e.g., 513 in FIG. 5) of the fragment 709 (e.g., 652 in FIG. 6) of the image data 706 (e.g., 584 in FIG. 5; 684 in FIG. 6) may be a pointer to data (e.g., fragment data) associated with the fragment 709 (e.g., 652 in FIG. 6) of the image data 706 (e.g., 584 in FIG. 5; 684 in FIG. 6), where the data comprises the resolution scale (e.g., of 517b in FIG. 5) and the set of offsets (e.g., of 517c, 517e in FIG. 5). In an example, 802 may be performed by the foveated coordinate patcher 198.

At 804, the apparatus may adjust, at a graphics processor and based on the resolution scale and the set of offsets, a set of initial coordinates of the fragment to obtain a set of patched coordinates of the fragment. For example, referring to FIG. 7, at 710, the graphics processor 704 may be configured to adjust, based on the resolution scale (e.g., of 517b in FIG. 5) and the set of offsets (e.g., of 517c, 517e in FIG. 5), initial or original coordinates (e.g., 532 in FIG. 5) (e.g., a set of initial coordinates) of the fragment 709 (e.g., 652 in FIG. 6) to obtain patched coordinates 711 (e.g., 515 in FIG. 5; 615 in FIG. 6) (e.g., a set of patched coordinates) of the fragment 709 (e.g., 652 in FIG. 6). In aspects, the graphics processor 704 and/or the RB (e.g., 516 in FIG. 5; 616 in FIG. 6) may be configured to perform hardware-based foveated coordinate patching (e.g., 514 in FIG. 5; 614 in FIG. 6) to generate or obtain the patched coordinates 711 (e.g., 515 in FIG. 5; 615 in FIG. 6) of the fragment 709 (e.g., 652 in FIG. 6) in hardware (e.g., by 516 in FIG. 5; by 616 in FIG. 6) (e.g., according to Eq. 1, noted above, and/or the like) and without software-based coordinate patching at a graphics driver (e.g., 510 in FIG. 5; 610 in FIG. 6). In aspects, to adjust (at 710), the graphics processor 704 and/or an RB (e.g., 516 in FIG. 5; 616 in FIG. 6) thereof may be configured to adjust, based on the resolution scale (e.g., of 517b in FIG. 5) and the set of offsets (e.g., of 517c, 517e in FIG. 5), the set of initial coordinates (e.g., 532 in FIG. 5) of the fragment 709 (e.g., 652 in FIG. 6), and to obtain, based on the adjusted set of initial coordinates of the fragment 709 (e.g., 652 in FIG. 6), the patched coordinates 711 (e.g., 515 in FIG. 5; 615 in FIG. 6) of the fragment 709 (e.g., 652 in FIG. 6). In an example, 804 may be performed by the foveated coordinate patcher 198.

At 806, the apparatus may output a coordinate indication of the set of patched coordinates. For example, referring to FIG. 7, at 712, the graphics processor 704 may be configured to output a coordinate indication 713 of the patched coordinates 711 (e.g., 515 in FIG. 5; 615 in FIG. 6) (e.g., a set of patched coordinates). In aspects, to output (at 712) the coordinate indication 713 of the patched coordinates 711 (e.g., 515 in FIG. 5; 615 in FIG. 6), the graphics processor 704 may be configured to provide the coordinate indication 713 of the patched coordinates 711 (e.g., 515 in FIG. 5; 615 in FIG. 6) to a shader (e.g., 518 in FIG. 5; 618 in FIG. 6) of the graphics processor, and/or to store the coordinate indication 713 of the patched coordinates 711 (e.g., 515 in FIG. 5; 615 in FIG. 6) in a memory (e.g., 521 in FIG. 5). In aspects, the coordinate indication 713 may comprise the patched coordinates 711 (e.g., 515 in FIG. 5; 615 in FIG. 6) and/or some other indication thereof. In aspects, the shader (e.g., 518 in FIG. 5; 618 in FIG. 6) of the graphics processor 704 may include at least one of a shader processor (e.g., 520 in FIG. 5; 620 in FIG. 6) or a shader controller (e.g., 522 in FIG. 5; 622 in FIG. 6). In an example, 806 may be performed by the foveated coordinate patcher 198.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining, for a fragment of image data, a resolution scale and a set of offsets associated with foveation; means for adjusting, at a graphics processor and based on the resolution scale and the set of offsets, a set of initial coordinates of the fragment to obtain a set of patched coordinates of the fragment; and means for outputting a coordinate indication of the set of patched coordinates.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: obtaining, for a fragment of image data, a resolution scale and a set of offsets associated with foveation; adjusting, at a graphics processor and based on the resolution scale and the set of offsets, initial coordinates of the fragment to obtain a set of patched coordinates of the fragment; and outputting a coordinate indication of the set of patched coordinates.

Aspect 2 is the method of aspect 1, wherein the resolution scale associated with the foveation is one of a full resolution, a downscaled-by-two resolution, or a downscaled-by-four resolution; and wherein the set of offsets associated with the foveation correspond to location coordinate changes, in one or more of two dimensions or in one or more of three dimensions, between image frames in the image data.

Aspect 3 is the method of aspect 2, wherein the image frames are partitioned over a set of bins, wherein the resolution scale and the set of offsets associated with the foveation correspond to one bin of the set of bins.

Aspect 4 is the method of any of aspects 1 to 3, wherein obtaining the resolution scale and the set of offsets associated with the foveation includes receiving the resolution scale and the set of offsets associated with the foveation via a set of hardware registers associated with a render backend of the graphics processor.

Aspect 5 is the method of any of aspects 1 to 3, wherein obtaining the resolution scale and the set of offsets associated with the foveation includes obtaining a fragment indication of the fragment of the image data associated with the foveation.

Aspect 6 is the method of aspect 5, wherein the fragment indication of the fragment of the image data is a pointer to data associated with the fragment of the image data, wherein the data comprises the resolution scale and the set of offsets.

Aspect 7 is the method of any of aspects 1 to 6, wherein the image data includes a fragment density map (FDM) associated with the fragment, wherein the set of offsets associated with the foveation includes at least one FDM offset based on the FDM.

Aspect 8 is the method of any of aspects 1 to 7, wherein the set of offsets includes respective per-view offsets associated with a set of views for the fragment of the image data.

Aspect 9 is the method of any of aspects 1 to 8, wherein outputting the coordinate indication of the set of patched coordinates includes at least one of: providing the coordinate indication of the set of patched coordinates to a shader of the graphics processor; or storing the coordinate indication of the set of patched coordinates in the memory.

Aspect 10 is the method of aspect 9, wherein the shader of the graphics processor includes at least one of a shader processor or a shader controller.

Aspect 11 is an apparatus for graphics processing comprising a processor coupled to a memory and, based on information stored in the memory, the processor is configured to implement a method as in any of aspects 1-10.

Aspect 12 may be combined with aspect 12 and comprises that the apparatus is a wireless communication device.

Aspect 13 is an apparatus for graphics processing comprising means for implementing a method as in any of aspects 1-10.

Aspect 14 is a computer-readable medium (e.g., a non-transitory computer readable-medium) storing computer executable code, the computer executable code, when executed by a processor, causes the processor to implement a method as in any of aspects 1-10.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
obtain, for a fragment of image data, a resolution scale and a set of offsets associated with foveation;
adjust, at a graphics processor and based on the resolution scale and the set of offsets, a set of initial coordinates of the fragment to obtain a set of patched coordinates of the fragment; and
output a coordinate indication of the set of patched coordinates.

2. The apparatus of claim 1, wherein the resolution scale associated with the foveation is one of a full resolution, a downscaled-by-two resolution, or a downscaled-by-four resolution; and
wherein the set of offsets associated with the foveation correspond to location coordinate changes, in one or more of two dimensions or in one or more of three dimensions, between image frames in the image data.

3. The apparatus of claim 2, wherein the image frames are partitioned over a set of bins, wherein the resolution scale and the set of offsets associated with the foveation correspond to one bin of the set of bins.

4. The apparatus of claim 1, wherein to obtain the resolution scale and the set of offsets associated with the foveation, the processor is configured to receive the resolution scale and the set of offsets associated with the foveation via a set of hardware registers associated with a render backend of the graphics processor.

5. The apparatus of claim 1, wherein to obtain the resolution scale and the set of offsets, the processor is configured to:
obtain a fragment indication of the fragment of the image data associated with the foveation.

6. The apparatus of claim 5, wherein the fragment indication of the fragment of the image data is a pointer to data associated with the fragment of the image data, wherein the data comprises the resolution scale and the set of offsets.

7. The apparatus of claim 1, wherein the image data includes a fragment density map (FDM) associated with the fragment, wherein the set of offsets associated with the foveation includes at least one FDM offset based on the FDM.

8. The apparatus of claim 1, wherein the set of offsets includes respective per-view offsets associated with a set of views for the fragment of the image data.

9. The apparatus of claim 1, wherein to output the coordinate indication of the set of patched coordinates, the processor is configured to at least one of:
provide the coordinate indication of the set of patched coordinates to a shader of the graphics processor; or
store the coordinate indication of the set of patched coordinates in the memory.

10. The apparatus of claim 9, wherein the shader of the graphics processor includes at least one of a shader processor or a shader controller.

11. The apparatus of claim 1, wherein the apparatus is a wireless communication device.

12. A method of graphics processing, comprising:
obtaining, for a fragment of image data, a resolution scale and a set of offsets associated with foveation;
adjusting, at a graphics processor and based on the resolution scale and the set of offsets, initial coordinates of the fragment to obtain a set of patched coordinates of the fragment; and
outputting a coordinate indication of the set of patched coordinates.

13. The method of claim 12, wherein the resolution scale associated with the foveation is one of a full resolution, a downscaled-by-two resolution, or a downscaled-by-four resolution; and
wherein the set of offsets associated with the foveation correspond to location coordinate changes, in one or more of two dimensions or in one or more of three dimensions, between image frames in the image data.

14. The method of claim 13, wherein the image frames are partitioned over a set of bins, wherein the resolution scale and the set of offsets associated with the foveation correspond to one bin of the set of bins.

15. The method of claim 12, wherein obtaining the resolution scale and the set of offsets includes: obtaining a fragment indication of the fragment of the image data associated with the foveation.

16. The method of claim 12, wherein the image data includes a fragment density map (FDM) associated with the fragment, wherein the set of offsets associated with the foveation includes at least one FDM offset based on the FDM.

17. The method of claim 12, wherein the set of offsets includes respective per-view offsets associated with a set of views for the fragment of the image data.

18. The method of claim 12, wherein outputting the coordinate indication of the set of patched coordinates includes at least one of:
providing the coordinate indication of the set of patched coordinates to a shader of the graphics processor; or
storing the coordinate indication of the set of patched coordinates in a memory.

19. The method of claim 18, wherein the shader of the graphics processor includes at least one of a shader processor or a shader controller.

20. A computer-readable medium storing computer executable code, the computer executable code, when executed by a processor, causes the processor to:
obtain, for a fragment of image data, a resolution scale and a set of offsets associated with foveation;
adjust, at a graphics processor and based on the resolution scale and the set of offsets, initial coordinates of the fragment to obtain a set of patched coordinates of the fragment; and
output a coordinate indication of the set of patched coordinates.
